(19) United States
(12) Patent Application Publication
(10) Pub. No.: US 2024/0349289 A1
(43) Pub. Date: Oct. 17, 2024

(54) WIRELESS COMMUNICATION METHOD, TERMINAL DEVICE, NETWORK DEVICE, AND CHIP

(71) Applicant: GUANGDONG OPPO MOBILE TELECOMMUNICATIONS CORP., LTD., Dongguan (CN)

(72) Inventors: Nande ZHAO, Dongguan (CN); Dongjun MA, Dongguan (CN)

(21) Appl. No.: 18/754,352

(22) Filed: Jun. 26, 2024

Related U.S. Application Data
(63) Continuation of application No. PCT/CN2022/070844, filed on Jan. 7, 2022.

(51) Int. Cl. H04W 72/21

(52) U.S. Cl. CPC H04W 72/21

(57) ABSTRACT

Provided is a method for wireless communication. The method includes: transmitting, by a terminal device, configured grant-uplink control information (CG-UCI) to a network device, wherein the CG-UCI indicates whether the network device is instructed to share a third COT using target COT sharing information, the third COT being a COT initiated by the terminal device, and the target COT sharing information comprising a duration and a time offset.

### CROSS-REFERENCE TO RELATED APPLICATION

This application is a continuation of International Application No. PCT/CN2022/070844, filed Jan. 7, 2022, the entire disclosure of which is incorporated herein by reference.

### TECHNICAL FIELD

Embodiments of the present disclosure relate to the technical field of mobile communications, and in particular, relate to a method for wireless communication, a terminal device, a network device, and a chip.

### BACKGROUND

In mobile communication systems, unlicensed bands, as supplements to licensed bands, help operators expand their services. For consistent deployment within a new radio (NR) system and maximization of unlicensed access based on the NR system, unlicensed bands operate in frequency bands of 5 GHZ, 37 GHz, and 60 GHz. A wide bandwidth of unlicensed bands (80 MHz or 100 MHz) reduces the implementation complexity of base stations (gNBs) and user equipments (UEs). However, because unlicensed bands are shared by various radio access technologies (RAT), such as wireless fidelity (Wi-Fi), radar, and long-term evolution license assisted access (LTE-LAA), some rules need to be observed during use of unlicensed bands, to ensure that all devices fairly use the resources. Such rules include Listen Before Talk (LBT), maximum channel occupancy time (MCOT), and the like.

### SUMMARY

Some embodiments of the present disclosure provide a method for wireless communication, a terminal device, a network device, and a chip.

The method for wireless communication according to some embodiments of the present disclosure includes:
transmitting, by a terminal device, configured grant-uplink control information (CG-UCI) to a network device, wherein the CG-UCI indicates whether the network device is instructed to share a third COT using target COT sharing information, the third COT being a COT initiated by the terminal device, and the target COT sharing information including a duration and a time offset.

The method for wireless communication according to some embodiments of the present disclosure includes:
receiving, by a network device, CG-UCI from a terminal device, wherein the CG-UCI indicate whether the network device is instructed to share a third COT using target COT sharing information, the third COT being a COT initiated by the terminal device, and the target COT sharing information including a duration and a time offset.

Some embodiments of the present disclosure further provide a communication device. The communication device is the terminal device in the above solutions or the network device in the above solutions, and the communication device includes a processor and a memory. The memory is configured to store one or more computer programs, and the processor, when loading and running the one or more computer programs stored in the memory, is caused to perform the method for wireless communication as described above.

Some embodiments of the present disclosure further provide a chip. The chip is configured to perform the method for wireless communication as described above.

The chip includes: a processor, wherein the processor, when loading and running one or more computer programs in a memory, causes a device equipped with the chip to perform the method for wireless communication as described above.

### BRIEF DESCRIPTION OF THE DRAWINGS

The accompanying drawings described herein, which provide a further understanding of the present disclosure, constitute a part of the specification. The embodiments of the present disclosure and the description thereof are provided to illustrate the present disclosure and do not constitute undue limitations on the present disclosure. In the accompanying drawings:

FIG. 1 is a schematic diagram of an application scenario according to some embodiments of the present disclosure;

FIG. 2 is a flowchart of a method for wireless communication according to some embodiments of the present disclosure;

FIG. 3 is a schematic diagram of COT sharing according to some embodiments of the present disclosure;

FIG. 4 is a schematic diagram of COT sharing according to some embodiments of the present disclosure;

FIG. 5 is a flowchart of a method for wireless communication according to some embodiments of the present disclosure;

FIG. 6 is a schematic diagram of COT sharing according to some embodiments of the present disclosure;

FIG. 7 is a flowchart of a method for wireless communication according to some embodiments of the present disclosure;

FIG. 8 is a schematic diagram of COT sharing according to some embodiments of the present disclosure;

FIG. 9 is a flowchart of a method for wireless communication according to some embodiments of the present disclosure;

FIG. 10 is a schematic diagram of COT sharing according to some embodiments of the present disclosure;

FIG. 11 is a schematic diagram of COT sharing according to some embodiments of the present disclosure;

FIG. 12 is a schematic diagram of COT sharing according to some embodiments of the present disclosure;

FIG. 13 is a schematic diagram of COT sharing according to some embodiments of the present disclosure;

FIG. 14 is a schematic diagram of COT sharing according to some embodiments of the present disclosure;

FIG. 15 is a schematic structural diagram of an apparatus for wireless communication according to some embodiments of the present disclosure;

FIG. 16 is a schematic structural diagram of an apparatus for wireless communication according to some embodiments of the present disclosure;

FIG. 17 is a schematic structural diagram of an apparatus for wireless communication according to some embodiments of the present disclosure;

FIG. 18 is a schematic structural diagram of an apparatus for wireless communication according to some embodiments of the present disclosure;

FIG. 19 is a schematic structural diagram of a communication device according to some embodiments of the present disclosure;

FIG. 20 is a schematic structural diagram of a chip according to some embodiments of the present disclosure; and

FIG. 21 is a schematic block diagram of a communication system according to some embodiments of the present disclosure.

### DETAILED DESCRIPTION

The technical solutions in the embodiments of the present disclosure will be described hereinafter with reference to the accompanying drawings in the embodiments of the present disclosure, and it is apparent that the described embodiments are only a part, but not all of the embodiments of the present disclosure. All other embodiments acquired by those of ordinary skills in the art without creative efforts with respect to the embodiments in the present disclosure shall fall within protection scope of the present disclosure.

FIG. 1 is a schematic diagram of an application scenario according to some embodiments of the present disclosure.

As shown in FIG. 1, the communication system 100 includes terminal devices 110 and a network device 120. The network device 120 communicates with the terminal devices 110 via an air interface. Multi-service transport is supported between the terminal devices 110 and the network device 120.

It is understandable that the embodiments of the present disclosure are only exemplified by the communication system 100, but the embodiments of the present disclosure are not limited thereto. That is, the technical solutions of the embodiments of the present disclosure are applicable to various communication systems, for example: a long-term evolution (LTE) system, an LTE time division duplex (TDD), a universal mobile telecommunications system (UMTS), an Internet of Things (IoT) system, a narrow band internet of things (NB-IoT) system, an enhanced machine-type communications (eMTC) system, a 5G communication system (also called new radio (NR) communication system), or a future communication system.

In the communication system 100 shown in FIG. 1, the network device 120 is an access network device that communicates with the terminal devices 110. The access network device provides communication coverage for a particular geographic region and communicates with terminal devices 110 (e.g., UEs) within the coverage region.

The network device 120 is an evolutional Node B (eNB or eNodeB) in an LTE system, or a next generation radio access network (NG RAN) device, or a base station (gNB) in an NR system, or a wireless controller in a cloud radio access network (CRAN), or the network device 120 is a relay station, an access point, a vehicle-mounted device, a wearable device, a hub, a switch, a bridge, a router, or a network device in a public land mobile network (PLMN) evolved in the future, or the like.

The terminal device 110 is any terminal device including, but not limited to, a terminal device in wired or wireless connection with the network device 120 or other terminal devices.

For example, the terminal device 110 refers to an access terminal, a UE, a subscriber unit, a subscriber station, a mobile terminal, a mobile station, a remote station, a remote terminal, a mobile device, a user terminal, a terminal, a wireless communication device, a user agent, or a user device. The access terminal is a cellular phone, a cordless phone, a Session Initiation Protocol (SIP) phone, an IoT device, a satellite handheld terminal, a wireless local loop (WLL) station, a personal digital assistant (PDA), a handheld device with a wireless communication function, a computing device or another processing device connected to a wireless modem, a vehicle-mounted device, a wearable device, a terminal device in a 5G network, or a terminal device in a future evolution network, or the like.

The wireless communication system 100 further includes a core network device 130 in communication with a base station, wherein the core network device 130 is a 5G core (5GC) device, such as an access and mobility management function (AMF), an authentication server function (AUSF), a user plane function (UPF), or a session management function (SMF). In some embodiments, the core network device 130 is an evolved packet core (EPC) device, such as a session management function+core packet gateway (SMF+PGW-C) device, of the LTE network. It is understandable that SMF+PGW-C performs the functions that SMF and PGW-C perform simultaneously. In the network evolution process, the core network device is also referred to as other names, or a new network entity is formed by splitting the functions of the core network, which are not limited in the embodiments of the present disclosure.

In some embodiments, the functional units in the communication system 100 communicate with each other by establishing connections via a next generation (NG) network interface.

For example, the terminal device establishes an air interface connection with the access network device via a Uu interface, wherein the air interface is configured to transmit user plane data and control plane signaling; the terminal device establishes a control plane signaling connection with the AMF over an NG interface 1 (N1 for short); the access network device, such as a next generation radio access base station (gNB), establishes a user plane data connection with the UPF over an NG interface 3 (N3 for short); the access network device establishes a control plane signaling connection with the AMF over an NG interface 2 (N2 for short); the UPF establishes a control plane signaling connection with the SMF over an NG interface 4 (N4 for short); the UPF exchanges user plane data with the data network over an NG interface 6 (N6 for short); the AMF establishes a control plane signaling connection with the SMF over an NG interface 11 (N11 for short); and the SMF establishes a control plane signaling connection with the PCF over an NG interface 7 (N7 for short).

FIG. 1 shows one base station, one core network device, and two terminal devices. In some embodiments, the system 100 for wireless communication includes a plurality of base station devices, and other number of terminal devices are included within the coverage region of each of the base stations, which are not limited in the embodiments of the present disclosure.

It should be noted that FIG. 1 illustrates, by way of example only, a system to which the present disclosure is applicable, and the method shown in the embodiments of the present disclosure is also applicable to other systems. Moreover, terms “system” and “network” herein are often used interchangeably. The phrase “and/or” herein is merely a way to describe the association relationship between associated objects, indicating that there are three possible relationships. For example, the phrase “A and/or B” means (A), (B), or (A and B). In addition, the symbol “/” herein generally indicates an “or” relationship between the associated objects. It is understandable that the term “indication” mentioned in the embodiments of the present disclosure is a direct indication, an indirect indication, or an indication that there is an association relationship. For example, A indicates B, which may mean that A indicates B directly, e.g., B is acquired by A; or that A indicates B indirectly, e.g., A indicates C, wherein B is acquired by C; or that an association relationship is present between A and B. It is understandable that the term “corresponding” mentioned in the embodiments of the present disclosure may indicate a direct corresponding relationship or an indirect corresponding relationship between two items, or indicate an associated relationship between two items. It may also indicate relationships such as indicating and being indicated, configuring and being configured, or the like. It is understandable that, the “predefined” or “predefined rule” mentioned in the embodiments of the present disclosure may be implemented by pre-storing a corresponding code, a table, or another manner that may indicate related information in a device (including, for example, a terminal device or a network device), and the present disclosure does not limit the specific implementation thereof. For example, “predefined” refers to “defined” in a protocol. It is understandable that, in the embodiments of the present disclosure, the “protocol” may refer to a standard protocol in the communication field. For example, the protocol includes an LTE protocol, an NR protocol, or a related protocol applied in future communication systems, which is not limited in the present disclosure.

For ease of understanding of the technical solutions in the embodiments of the present disclosure, the following explanation is provided for related technologies of the embodiments of the present disclosure. The following related technologies are considered as optional solutions and can be combined in any way with the technical solutions in the embodiments of the present disclosure, all falling within the protection scope of the embodiments of the present disclosure.

A transmitter node, which is also referred to as an initiating device, may include a base station and a UE. In the case that the transmitter node acquires a channel, the transmitter node may share a channel occupancy time (COT) with a receiver node, wherein the receiver is also referred to as a responding device, and the receiver node may include a UE and a base station. That is, in the case that the base station is the initiating device, the UE is the responding device; and in the case that the UE is the initiating device, the base station is the responding device.

A COT sharing manner of the configured grant (CG)-physical uplink shared channel (PUSCH) is as follows.

In the NRU system, in the case that the base station shares a COT initiated by the UE due to the transmission of CG-PUSCH, the base station may transmit downlink transmission after the CG-PUSCH transmission, which is as follows.
In the case that the base station provides an energy detection threshold for COT sharing, i.e. the higher-layer parameter ul-toDL-COT-SharingED-Threshold-r16, then the higher layer configures the UE in tabular form over the parameter cg-COT-SharingList-r16. Each row in the table is provided with COT sharing information by the higher-layer parameter CG-COT-Sharing-r16, and one row in the table indicates that COT sharing is not available.
In the case that slot n detects CG-uplink control information (UCI) indicating a row index in the table, wherein the row index is provided with COT sharing information by the higher-layer parameter CG-COT-Sharing-r16, then the base station starts sharing the COT initiated by the UE from slot n+O, wherein the offset value O=offset-r16 slots, duration D=duration-r16, and channel access priority p=channelAccessPriority-r16. The duration-r16, the offset-r16, and the channelAccessPriority-r16 are provided by the higher-layer parameter CG-COT-Sharing-r16.
If the higher-layer parameter ul-toDL-COT-SharingED-Threshold-r16 is not provided and the COT sharing information in the CG-UCI indicates ‘1’, then the base station starts sharing the COT initiated by the UE from Xin symbol upon detecting a slot where CG-UCI is located, wherein X=cg-COT-SharingOffset-r16 and the cg-COT-SharingOffset-r16 is provided by the higher layer. Transmission should not include any unicast transmission with user plane data, and transmission time should not exceed 2/4/8 symbols corresponding to subcarrier spacing of 15 kHz/30 kHz/60 kHz.

### Channel Access Type Switching

In the NRU system, in the case that the UE determines duration and frequency domain position of the COT initiated by the base station over DCI 2_0, the following process is applied:
In the case that uplink transmission of the UE is performed within time-frequency domain resources corresponding to the COT initiated by the base station, the UE switches from Type-1 channel access to Type-2A channel access.

In the NRU system of the related art, the base station configures the energy detection threshold for COT sharing for the UE. In this case, the UE uses the energy detection threshold configured at a higher layer for channel access. However, with respect to high-frequency unlicensed bands, the UE, during the channel access process, only considers its maximum EIRP within the COT, that is, without introducing relevant parameters of the energy detection threshold for COT sharing. In this case, some restrictions on COT sharing for CG-PUSCH in the NRU system is not applicable, a redesign of the COT sharing manner in high frequencies is required.

In addition, in the NRU system, the UE is supported to switch from Type-1 LBT to Type-2A LBT in a COT-sharing mode.

In the NRU system, in the case that the UE detects that its uplink transmission is performed in a COT initiated by the base station, the UE switches from the Type-1 channel access to the Type-2A channel access in the COT-sharing mode.

In high frequencies, two types of COT-sharing modes are supported:

1) When sharing a COT, the UE does not need to perform LBT (i.e., Type-3 LBT) and can transmit directly.

2) When sharing a COT, in the case that an interval between transmission of the UE and transmission of the base station falls within a specified gap, there is no need to perform LBT, and transmission can proceed directly. Otherwise, Type-2 LBT needs to be performed prior to transmission.

Therefore, with respect to the switching of channel access types in high frequencies, it is necessary to determine which channel access type to switch to from the Type-1 channel access.

In the NR-unlicensed (NRU) system, UEs are supported to switch from Type-1 LBT to Type-2A LBT by sharing a channel occupancy time (COT). In the related art, there is no designed manner for channel access type switching involving high frequencies, and the switching manner of NRU is not applicable to high frequencies.

For facilitating understanding of the technical solutions of the embodiments of the present disclosure, the technical solutions of the present disclosure are described in detail hereinafter with embodiments. As an alternative, the related technologies above may be combined with the technical solutions of the embodiments of the present disclosure in any manner, all of which fall within protection scope of the embodiments of the present disclosure. The embodiments of the present disclosure include at least some of the following.

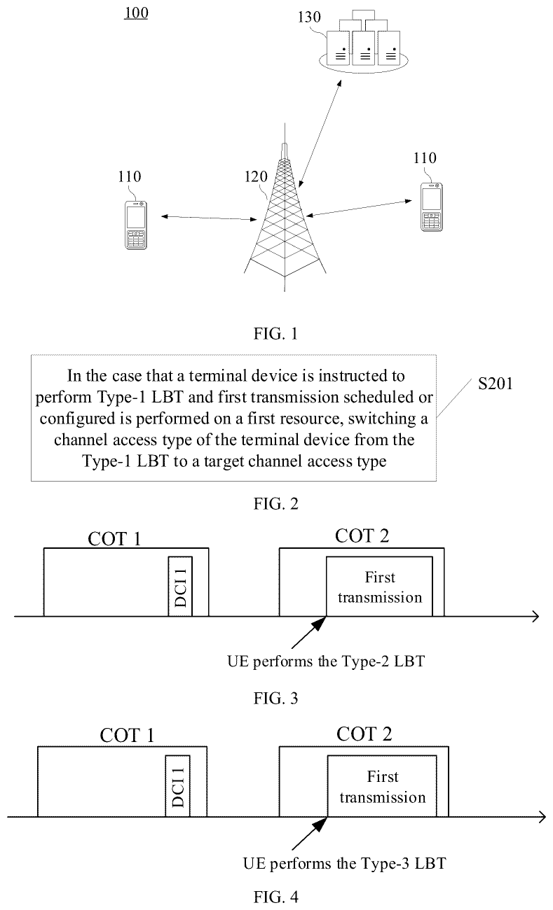

Some embodiments of the present disclosure provide a method for wireless communication. The method is applicable to a terminal device. As shown in FIG. 2, the method includes the following process.

In S201, in the case that a terminal device is instructed to perform Type-1 LBT and first transmission scheduled or configured is carried on the first resource, a channel access type of the terminal device is switched from the Type-1 LBT to a target channel access type.

The first resource is a resource corresponding to a first COT (COT 1), wherein the COT 1 is initiated by a network device. The target channel access type includes Type-2 LBT or Type-3 LBT.

The terminal device and network device support high frequencies from 52.6 GHz to 71 GHz, and communication between the terminal device and the network device is based on the high frequencies from 52.6 GHz to 71 GHz. In some embodiments, the terminal device and network device operate in frequency bands outside the range of 52.6 GHz to 71 GHz, such as FR1 and FR2.

In the embodiments of the present disclosure, in the case that the terminal device is instructed to perform the Type-1 LBT, and the first transmission scheduled or configured is carried on the first resource, the terminal device considers that a condition for channel access type switching is currently met and proceeds with the channel access type switching. In this case, the terminal device determines the target channel access type and switches the channel access type from the Type-1 LBT to the target channel access type, wherein the target channel access type includes the Type-2 LBT or the Type-3 LBT.

In some embodiments, the channel access type of the terminal device is switched from the Type-1 LBT to the Type-2 LBT.

In some embodiments, the channel access type of the terminal device is switched from the Type-1 LBT to the Type-3 LBT.

In some embodiments, the network device instructs the terminal device to perform the Type-1 LBT by transmitting first DCI (DCI 1) to the terminal device. In this case, the COT for instructing the UE to perform the Type-1 LBT and the COT for transmitting the first transmission (i.e., the COT 1) are not the same COT. The DCI 1 may be transmitted in a previous COT of the COT 1.

The first transmission is an uplink transmission scheduled by the network device or configured at a higher layer.

In the case that the first transmission is scheduled by the network device, the first transmission is scheduled by the DCI 1. In this case, the network device transmits the DCI 1 to the terminal device, and the terminal device receives the DCI 1 from the network device. Based on the DCI 1, the terminal device determines that the first transmission is scheduled and determines that the terminal device is instructed to perform the Type-1 LBT.

In some embodiments of the present disclosure, the first transmission is the PUSCH. In the case that the first transmission is configured at the higher layer, the first transmission is the CG-PUSCH.

In some embodiments, the network device transmits second DCI (DCI 2) to the terminal device during the COT 1, wherein the DCI 2 indicates information of the COT 1. In this case, based on the DCI 2, the terminal device determines that the first transmission scheduled by the DCI 1 or the first transmission configured at the higher layer is carried on the first resource corresponding to the COT 1, and the terminal device determines to switch the channel access type.

Upon determining the target channel access type and acquiring the first resource, the terminal device accesses the channel based on the target channel access type, and transmits the first transmission upon accessing the channel successfully.

Some embodiments of the present disclosure provide a method for wireless communication. Referring to the FIG. 3, the network device transmits first DCI (DCI 1) to the terminal device on a first COT (COT 1), wherein the DCI 1 indicates that the terminal device is instructed to perform the Type-1 LBT. In the case that first transmission scheduled by the DCI 1 or configured at the higher layer is carried on the resource corresponding to a second COT (COT 2), the terminal device performs the Type-2 LBT, i.e., channel access based on the Type-2 LBT, prior to starting to transmit the first transmission, and upon accessing the channel successfully, the terminal device transmits the first transmission in the COT 2.

Some embodiments of the present disclosure provide a method for wireless communication. Referring to the FIG. 4, the network device transmits DCI 1 to the terminal device on a first COT (COT 1), wherein the DCI 1 indicates that the terminal device is instructed to perform the Type-1 LBT. In the case that the first transmission scheduled by the DCI 1 or configured at the higher layer is carried on a resource corresponding to a second COT (COT 2), the terminal device performs the Type-3 LBT, i.e., channel access based on the Type-3 LBT, prior to transmitting the first transmission, and upon accessing the channel successfully, the terminal device transmits the first transmission in the COT 2.

In the embodiments of the present disclosure, upon accessing the channel successfully, the terminal device is considered as sharing the COT initiated by the network device or initiating a new COT.

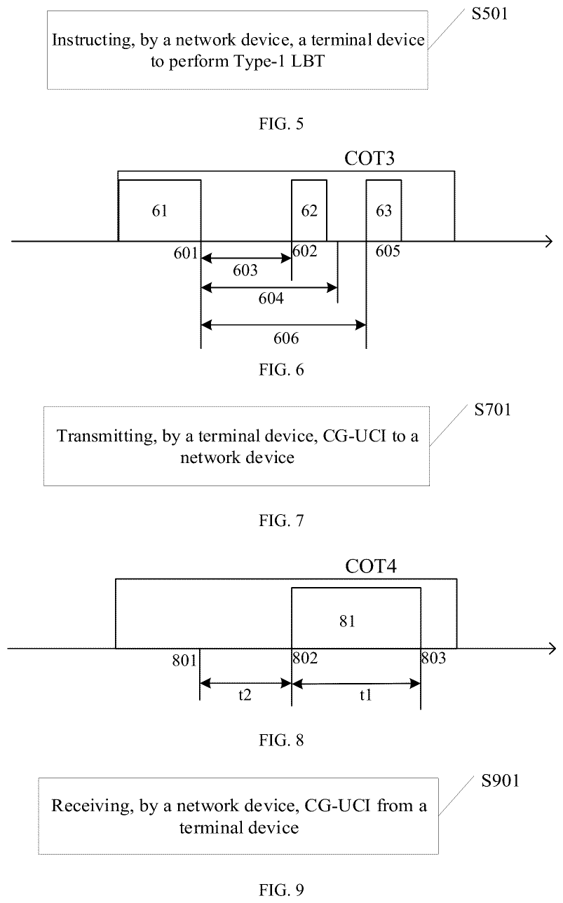

Some embodiments of the present disclosure provide a method for wireless communication. The method is applicable to a network device. As shown in FIG. 5, the method includes the following process.

In S501, the network device instructs a terminal device to perform Type-1 LBT.

The first transmission scheduled or configured for the terminal device is carried on a first resource. The channel access type of the terminal device is switched from the Type-1 LBT to a target channel access type. The first resource is a resource corresponding to a first COT (COT 1), wherein the COT 1 is a COT initiated by the network device, and the target channel access type is Type-2 LBT or Type-3 LBT.

The terminal device and network device support high frequencies from 52.6 GHZ to 71 GHz, and communication between the terminal device and the network device is based on the high frequencies from 52.6 GHz to 71 GHz. In some embodiments, the terminal device and network device operate in frequency bands outside the range of 52.6 GHz to 71 GHz, such as FR1 and FR2.

In the embodiments of the present disclosure, the network device instructs the terminal device to perform the Type-1 LBT. In the case that the terminal device is instructed by the network device to perform the Type-1 LBT, and the first transmission scheduled or configured is carried on the first resource, the terminal device considers that a condition for channel access type switching is currently met and proceeds with the channel access type switching. The terminal device switches the channel access type. In this case, the terminal device determines the target channel access type and switches from the Type-1 LBT to the target channel access type, wherein the target channel access type includes the Type-2 LBT or the Type-3 LBT.

In some embodiments, the channel access type of the terminal device is switched from the Type-1 LBT to the Type-2 LBT.

In some embodiments, the channel access type of the terminal device is switched from the Type-1 LBT to the Type-3 LBT.

In some embodiments, the network device instructs the terminal device to perform the Type-1 LBT by transmitting first DCI (DCI 1) to the terminal device. In this case, the COT for instructing the UE to perform the Type-1 LBT and the COT for transmitting the first transmission (i.e., the COT 1) are not the same COT. The DCI I may be transmitted in a previous COT of the COT 1.

The first transmission is an uplink transmission scheduled by the network device or configured at a higher layer.

In the case that the first transmission is scheduled by the network device, the first transmission is scheduled by the DCI 1. In this case, the network device transmits the DCI 1 to the terminal device, and the terminal device receives the DCI 1 from the network device. Based on the DCI 1, the terminal device determines that the first transmission is scheduled and determines that the terminal device is instructed to perform the Type-1 LBT.

In some embodiments of the present disclosure, the first transmission is the PUSCH. In the case that the first transmission is configured at the higher layer, the first transmission is the CG-PUSCH.

In some embodiments, the network device transmits second DCI (DCI 2) to the terminal device in the COT 1, wherein the DCI 2 indicates information of the COT 1. In this case, based on the DCI 2, the terminal device determines that the first transmission scheduled by the DCI 1 or the first transmission configured at the higher layer is carried on the first resource corresponding to the COT 1, and the terminal device determines to switch the channel access type.

Upon determining the target channel access type and acquiring the first resource, the terminal device accesses the channel access based on the target channel access type, and transmits the first transmission upon accessing the channel successfully.

Some embodiments of the present disclosure provide a method for wireless communication. Referring to the FIG. 3, the network device transmits DCI 1 to the terminal device on a first COT (COT 1), wherein the DCI 1 indicates that the terminal device is instructed to perform the Type-1 LBT. In the case that the first transmission scheduled by the DCI 1 or configured at the higher layer is carried on a resource corresponding to a second COT (COT 2), the terminal device performs Type-2 LBT channel access prior to starting to transmit the first transmission, and upon accessing the channel successfully, the terminal device transmits the first transmission in the COT 2.

Some embodiments of the present disclosure provide a method for wireless communication. Referring to the FIG. 4, the network device transmits first DCI (DCI 1) to the terminal device in a first COT (COT 1), wherein the DCI 1 indicates the terminal device is instructed to perform the Type-1 LBT. In the case that the first transmission scheduled by the DCI 1 or configured at the higher layer is carried on a resource corresponding to a second COT (COT 2), the terminal device performs Type-3 LBT channel access prior to transmitting the first transmission, and upon accessing the channel successfully, the terminal device transmits the first transmission in the COT 2.

In the embodiments of the present disclosure, upon accessing the channel successfully, the terminal device is considered as sharing the COT initiated by the network device or initiating a new COT.

In the embodiments of the present disclosure, the method for determining the target channel access type includes either of determining method 1 or determining method 2.

Determining method 1: The channel access type is the Type-2 LBT.

Determining method 2: The channel access type is determined based on whether the terminal device is configured with first indication information.

In the determining method 1, the target channel access type is always the Type-2 LBT. In the case that the terminal device switches the channel access type, the channel access type of the terminal device is always switched from the Type-1 LBT to the Type-2 LBT. Thus, the terminal device switches from the Type-1 LBT to the Type-2 LBT in a COT-sharing mode, thereby simplifying the LBT process.

Taking the determining method 1 as an example for determining the target channel access type, in the case that the terminal device supports the Type-2 LBT, the target channel access type is the Type-2 LBT.

In the determining method 2, the target channel access type is determined based on whether the terminal device is configured with the first indication information. The first indication information indicates whether the network device is configured with a first interval, wherein the first interval is configured to determine the channel access type of the network device on a second COT (COT 2), the COT 2 being a COT initiated by the terminal device.

Herein, the first indication information indicates whether the network device is configured with the first interval. In some embodiments, the network device determines whether to configure the first indication information to the terminal device based on whether the network device is configured with the first interval. In the case that the network device is configured with the first interval, the network device configures the first indication information to the terminal device, indicating to the terminal device that the network device is configured with the first interval. In this case, the terminal device is configured with the first indication information, and the terminal device determines that the network device is configured with the first interval based on the configured first indication information. In the case that the network device is not configured with the first interval, the network device does not configure the first indication information to the terminal device, indicating to the terminal device that the network device is not configured with the first interval. In this case, the terminal device is not configured with the first indication information, and the terminal device determines that the network device is not configured with the first interval based on the unconfigured first indication information.

In some embodiments, time unit of the first interval is a listen slot, millisecond, subframe, or the like. In some embodiments, one listen slot equals 8 milliseconds.

In the embodiments of the present disclosure, in the case that the network device is not configured with the first interval and shares the COT, the network device does not need to perform LBT (i.e. the Type-3 LBT) and directly transmits. In the case that the network device is configured with the first interval and shares the COT, the network device determines the channel access type to be the Type-2 LBT or the Type-3 LBT based on a relationship between an interval between the terminal device's transmission and the network device's transmission (i.e., the first interval) and the first interval. In the case that the first interval falls within the first interval, the network device's channel access type is the Type-3 LBT; and in the case that the first interval does not fall within the first interval, the network device's channel access type is the Type-2 LBT.

As shown in FIG. 6, the network device is configured with the first interval, and the network device accesses the channel in a manner of sharing the COT initiated by the terminal device. In a third COT (COT 3), in the case that transmission 61 of the terminal device ends at time 601 and the network device shares the COT 2, transmission 62 of the network device begins at time 602, then an interval 603 between the time 601 and the time 602 is less than the first interval 604, such that the network device's channel access type is the Type-3 LBT; and in the case that the transmission of the terminal device ends at the time 601 and the network device shares the COT 2, transmission 63 of the network device begins at time 605, then an interval 606 between the time 601 and the time 605 is greater than the first interval 604, such that the network device's channel access type is the Type-2 LBT.

In the case that the determining method 2 is used, the terminal device determines the target channel access type as the Type-2 LBT or the Type-3 LBT based on whether the terminal device is configured with the first indication information.

In some embodiments, the first indication information indicates the first interval.

In the case that the first indication information indicates the first interval, the terminal device determines the target channel access type based on whether the terminal device is configured with the first interval.

In some embodiments, in the case that the terminal device is not configured with the first indication information, the target channel access type is the Type-3 LBT; or in the case that the terminal device is configured with the first indication information, the target channel access type is the Type-2 LBT.

In the case that the terminal device is not configured with the first indication information, the target channel access type is the Type-3 LBT. In this case, the channel access type of the terminal device is switched from the Type-1 LBT to the Type-3 LBT, that is, no LBT is required, and transmission is performed directly. In the case that the terminal device is configured with the first indication information, the target channel access type is the Type-2 LBT. In this case, the channel access type of the terminal device is switched from the Type-1 LBT to the Type-2 LBT.

In the case that the first indication information indicates the first interval, if the terminal device is not configured with the first indication information, the target channel access type is the Type-3 LBT; and if the terminal device is configured with the first interval, the target channel access type is the Type-2 LBT.

In some embodiments, in the case that the terminal device is not configured with the first indication information, the terminal device determines that the network device does not need to perform LBT and directly transmits, and the terminal device transmits directly in the COT-sharing mode without performing LBT (i.e., the Type-3 LBT). In the case that the network device is configured with the first interval, considering that the terminal device is unaware of ending time of the downlink transmission, the interval between transmission of the terminal device and transmission of the network device (i.e., the first interval) is assumed as falling outside the first interval. In this case, the terminal device switches the channel access type from the Type-1 LBT to the Type-2 LBT in the COT-sharing mode.

In some embodiments, the method for configuring the first indication information includes at least one of configuring method 1 or configuring method 2.

Configuring method 1: The first indication information is indicated over a system message.

Configuring method 2: The first indication information is configured at the high layer.

In the case that configuring method for configuring the first indication information is the configuring method 1, the system message transmitted to the terminal device by the network device carries the first indication information.

In some embodiments, the first indication information is configured over the system information block (SIB) 1 in the system message.

In the case that configuring method for configuring the first indication information is the configuring method 2, the first indication information is configured at the higher layer. The higher layer may be the radio resource control (RRC) layer.

In some embodiments, in the case that the terminal device does not support the Type-2 LBT, the channel access type of the terminal device remains the Type-1 LBT.

Herein, in the case that the terminal device meets the condition for channel access type switching, regardless of whether the target channel access type is determined as the Type-2 LBT based on the determining method 1 or the determining method 2, with respect to the terminal device that does not support the Type-2 LBT, the channel access type of the terminal device is returned to the Type-1 LBT. That is, prior to staring the first transmission, the terminal device still performs the Type-1 LBT.

In some embodiments, in the case that the first transmission is not scheduled or configured to be performed on the first resource, the terminal device accesses the channel based on the Type-1 LBT.

In the case that the terminal device is instructed to perform the Type-1 LBT but the transmission resource of the first transmission scheduled or configured is not in the COT 1, the terminal device does not meet the condition for channel access type switching. In this case, the terminal device does not meet the condition for channel access type switching and does not perform the channel access type switching. The terminal device shares the COT 1 by accessing the channel based on the Type-1 LBT.

Some embodiments of the present disclosure provide a method for wireless communication. As shown in FIG. 7, the method includes the following process.

In S701, a terminal device transmits CG-UCI to a network device.

The CG-UCI indicates whether the network device is instructed to share a third COT (COT 3) using target COT sharing information, wherein the COT 3 is a COT initiated by the terminal device, and the target COT sharing information includes a duration and a time offset.

In some embodiments, the CG-UCI is carried in the uplink transmission scheduled by the network device or in the configured uplink transmission. In some embodiments, the uplink transmission scheduled by the network device or the configured uplink transmission is the first transmission.

In some embodiments, the CG-UCI is carried in the configured first transmission. In this case, the method for wireless communication shown in FIG. 7 is performed based on the method for wireless communication shown in FIG. 2.

In some embodiments, the CG-UCI is not carried in the first transmission. In this case, there is no association between the method for wireless communication shown in FIG. 2 and the method for wireless communication shown in FIG. 7.

The terminal device transmits the CG-UCI to the network device. In the case that the CG-UCI indicates that the network device is instructed not to share the COT initiated by the terminal device, i.e., the COT 3, the network device does not share the COT 3. In the case that the CG-UCI indicates that the network device is instructed to share the COT initiated by the terminal device, i.e., the COT 3, the network device shares the COT 3

In the case that the network device shares the COT 3, the network device shares the COT 3 using the target COT sharing information. The target COT sharing information is sharing information indicated by the CG-UCI or fixed sharing information.

Herein, the target COT sharing information includes the duration and the time offset. The duration is a length of time for which the network device shares the COT 3. The time offset indicates time at which the network device starts sharing the COT 3. In the case that the network device receives the CG-UCI from the terminal device, starting from reception of the CG-UCI, the network device starts sharing the COT 3 after the time offset.

As shown in FIG. 8, the COT initiated by the terminal device is a fourth COT (COT 4), with a duration of t1 and a time offset of t2. In this case, the network device receives the CG-UCI from the terminal device at time 801, starts sharing the COT 4 at time 802, and shares the COT 4 between the time 802 and time 803. That is, downlink transmission 81 is performed in the COT 4 between the time 802 and the time 803. The duration between the time 801 and the time 802 is t2, and the duration between the time 802 and the time 803 is t1.

In the embodiments of the present disclosure, the COT 2 and the COT 3 are the same COT or different COTs.

The COT 2 is the COT initiated by the terminal device and accessed by the network device in the COT-sharing mode, wherein the channel access type is determined based on the first interval by the network device. The COT 3 is a shared time initiated by the terminal device and determined to be shared to the network device based on the CG-UCI.

In the case that the COT initiated by the terminal device is shared with the network device, the channel access type of the network device is determined based on the first interval, and shared time given to the network device is determined based on the CG-UCI. In this case, the COT can be understood as the COT 2, and the COT may also be understood as the COT 3.

Some embodiments of the present disclosure provide a method for wireless communication. As shown in FIG. 9, the method includes the following process.

In S901, a network device receives CG-UCI from a terminal device.

The CG-UCI indicates whether the network device is instructed to share a third COT (COT 3) using target COT sharing information, wherein the COT 3 is a COT initiated by the terminal device, and the target COT sharing information includes a duration and a time offset.

In some embodiments, the CG-UCI is carried in the uplink transmission scheduled by the network device or in the configured uplink transmission. In some embodiments, the uplink transmission scheduled by the network device or the configured uplink transmission is the first transmission.

In some embodiments, the CG-UCI is carried in the configured first transmission. In this case, the method for wireless communication shown in FIG. 9 is performed based on the method for wireless communication shown in FIG. 5.

In some embodiments, the CG-UCI is not carried in the first transmission. In this case, there is no association between the method for wireless communication shown in FIG. 5 and the method for wireless communication shown in FIG. 9.

The terminal device transmits the CG-UCI to the network device. In the case that the CG-UCI indicates that the network device is instructed not to share the COT initiated by the terminal device, i.e., the COT 3, the network device does not share the third COT. In the case that the CG-UCI indicates that the network device is instructed to share the COT initiated by the terminal device, i.e., the COT 3, the network device shares the COT 3.

In the case that the network device shares the COT 3, the network device shares the COT 3 using the target COT sharing information. The target COT sharing information is the sharing information indicated by the CG-UCI or fixed sharing information.

Herein, the target COT sharing information includes the duration and the time offset. The duration is a length of time for which the network device shares the COT 3. The time offset indicates time at which the network device starts sharing the COT 3. In the case that the network device receives the CG-UCI from the terminal device, starting from reception of the CG-UCI, the network device starts sharing the COT 3 after the time offset.

As shown in FIG. 8, the COT initiated by the terminal device is a fourth COT (COT 4), with a duration of t1 and a time offset of t2. In this case, the network device receives the CG-UCI from the terminal device at time 801, starts sharing the COT 4 at time 802, and shares the COT 4 between the time 802 and time 803. That is, downlink transmission 81 is performed in the COT 4 between the time 802 and the time 803.

In the embodiments of the present disclosure, the COT 2 and the COT 3 are the same COT or different COTs.

The COT 2 is the COT initiated by the terminal device and accessed by the network device in the COT-sharing mode, wherein the channel access type is determined based on the first interval. The COT 3 is a shared time initiated by the terminal device and determined to be shared to the network device based on the CG-UCI.

In the case that the COT initiated by the terminal device is shared with the network device, the channel access type of the network device is determined based on the first interval, and shared time given to the network device is determined based on the CG-UCI. In this case, the COT can be understood as the COT 2, and the COT may also be understood as the COT 3.

In some embodiments, the duration is less than 320 slots.

In some embodiments of the present disclosure, a value range of the duration is {1 . . . 319}, that is, within the third COT, a value range of the number of slots in which the base station performs downlink transmission is {1 . . . 319}.

In some embodiments, the target COT sharing information does not include parameters related to channel access priority.

In the embodiments of the present disclosure, the concept of channel access priority is not introduced in high frequencies. Therefore, parameters related to channel access priority are not required to be introduced into the target COT sharing information.

In some embodiments of the present disclosure, the CG-UCI carries at least one of information 1 or information 2.

Information 1: Index information.

Information 2: Sharing indication information.

In the case that the CG-UCI carries the information 1, the target COT sharing information is determined based on index information and sharing information list (cg-COT-SharingList) carried by the UCI. In this case, the network device determines the target COT sharing information based on the index information and the configured sharing information list carried in the CG-UCI. The sharing information list includes one or more pieces of COT sharing information (CG-COT-Sharing). Different pieces of COT sharing information are located in different rows of the sharing information list, and the pieces of COT sharing information of different rows corresponds to different index information. In the embodiments of the present disclosure, duration or time offset in different pieces of COT sharing information are different.

In some embodiments, the sharing information list includes COT sharing information 1, COT sharing information 2, COT sharing information 3, COT sharing information 4, wherein index information corresponding to the COT sharing information 1, the COT sharing information 2, the COT sharing information 3, and the COT sharing information 4 are respectively index 1, index 2, index 3, and index 4. In the case that the index information carried in the CG-UCI is the index 4, the target COT sharing information is the COT sharing information 4.

In some embodiments, the sharing information list is configured at the higher layer of the network device.

In some embodiments, in the case that the index information corresponds to the first information in the sharing information list, the CG-UCI indicates that the network device is instructed not to share the COT 3, and the first information indicates that COT sharing is not available.

Herein, a row in the sharing information list is reserved for the first information indicating that the COT sharing is not available, i.e., the first information indicates that the COT cannot be shared. In the case that the index information in the CG-UCI indicates the first information, the CG-UCI indicates that the network device is instructed not to share the COT 3. In this case, the network device does not share the COT 3.

In some embodiments, the first information is unshared information (noCOT-sharing). In the case that the index information carried in the CG-UCI corresponds to the noCOT-sharing, the CG-UCI indicates that the network device is instructed not to share the COT 3.

In some embodiments, in the case that the index information corresponds to the sharing information in the sharing information list, the CG-UCI indicates that the network device is instructed to share the COT 3 using target COT sharing information. The target COT sharing information is the sharing information corresponding to the index information in the sharing information list.

The sharing information list includes one or more pieces of sharing information, i.e., COT sharing information. In the case that the index information carried in the CG-UCI corresponds to the sharing information in the sharing information list, the CG-UCI indicates that the network device is instructed to share the COT 3 and use the sharing information corresponding to the index information carried in the CG-UCI in the sharing information list as the target COT sharing information to share the COT 3. The sharing parameters in the sharing information list are {duration, time offset (offset)}.

In some embodiments, the parameters in the sharing information list include: noCOT-sharing, {duration1, offset1}, {duration2, offset2}, {duration3, offset3}, {duration4, offset4}, and {duration5, offset5}, wherein indexes corresponding to the parameters are 01, 02, 03, 04, 05, and 06. In the case that the index information carried in the CG-UCI is 01 which corresponds to the noCOT-sharing, the CG-UCI indicates that the network device is instructed not to share the COT 3. In the case that the index information carried in the CG-UCI is 03 which corresponds to {duration4, offset4}, the CG-UCI indicates that the network device is instructed to share the COT 3 and use {duration4, offset4} to share the COT 3.

In the case that the CG-UCI carries the information 2, the information 2 indicates whether the network device is instructed to share the COT 3. In this case, the sharing information list is not introduced. The target COT sharing information is the fixed sharing information configured, and the network device shares the COT 3 based on the fixed sharing information configured serving as the target COT sharing information.

In some embodiments, the configured sharing information includes cg-COT-SharingOffset and cg-COT-SharingDuration. The cg-COT-SharingOffset indicates the number of spaced slots between detection of the CG-UCI and start of downlink transmission by the network device, with a value range of {1 . . . 319}. The cg-COT-SharingDuration indicates the number of slots in which the base station performs downlink transmission within the COT 3, with a value range of {1 . . . 319}.

In some embodiments, the sharing information is the sharing information configured at the higher layer of the network device.

In some embodiments, the CG-UCI carries the second information, wherein a value of the second information indicates whether the network device is configured to share the COT 3. In the case that the network device is configured to share the COT 3, the network device shares the COT 3 using the target COT sharing information.

Herein, the second information is the sharing indication information. The sharing indication information, based on different values, indicates whether the network device is configured to share the COT 3. Herein, the sharing indication information is N-bit information, wherein N is greater than or equal to 1.

In some embodiments, the second information taking a first value indicates that the network device is configured to share the COT 3; or the second information taking a second value indicates that the network device is not configured to share the COT 3.

In the embodiments of the present disclosure, the first value and the second value are different values.

In the case that the terminal device determines that the network device is configured to share the COT 3, the value of the second information is set to the first value. In this case, the network device, in response to receiving the second information taking the first value, determines that the network device is configured to share the COT 3 and shares the COT 3 based on the configured sharing information.

In the case that the terminal device determines that the network device is not configured to share the COT 3, the value of the second information is set to the second value. In this case, the network device, in response to receiving the second information taking the second value, determines that the network device is not configured to share the COT 3.

In some embodiments, the sharing indication information is 1-bit information. In the case that the bit is 0, the bit indicates that the network device cannot share the COT initiated by the terminal device, and in the case that the bit is 1, the bit indicates that the network device can share the COT initiated by the terminal device. In the case that the network device detects that the bit value of the sharing indication information in the CG-UCI is 1, the network device determines that the network device can share the COT initiated by the terminal device. In this case, the network device starts sharing the COT initiated by the UE from slot n+O, and performs downlink transmission for D slots, wherein O represents the configured offset time, and D represents the configured duration.

With the above technical solutions, in high frequencies, the terminal device switches the channel access type from the Type-1 LBT to the Type-2 LBT or the Type-3 LBT by sharing the COT initiated by the network device, thereby adapting to the COT sharing in high frequencies.

A method for wireless communication according to the embodiments of the present disclosure is further described hereinafter.

Some embodiments of the present disclosure provide a COT sharing manner for CG-PUSCH in high-frequency unlicensed bands, and provide a design for determining the type of channel access to switch to based on a currently applied COT-sharing mode in the high-frequency unlicensed bands.

### COT Sharing Manner for CG-PUSCH in the High Frequencies

High frequencies support the COT sharing manner from uplink to downlink, that is, the base station shares the COT (the COT 3) initiated by the UE, which includes the scenario where the UE transmits dynamically scheduled uplink transmission and CG-PUSCH. Since relevant parameters of the energy detection threshold for COT sharing are not introduced in the high frequencies, it is necessary to design how the base station shares the COT initiated by the UE when transmitting CG-PUSCH without the parameters.

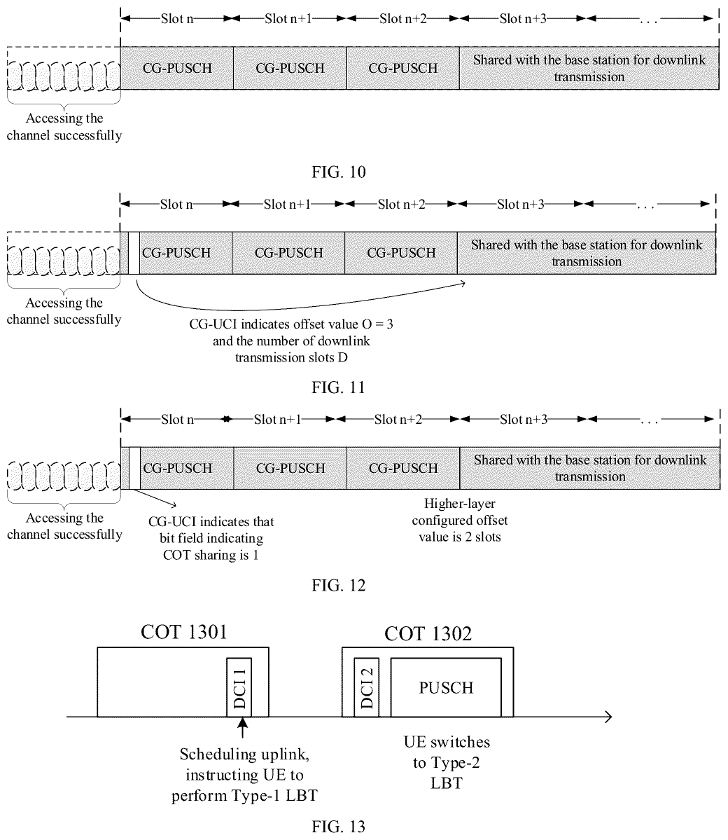

In some embodiments, the COT sharing manner from uplink to downlink is shown in FIG. 10. Upon accessing the channel successfully based on the Type1, the UE performs uplink transmission of CG-PUSCH in slots n, n+1, and n+2, and then shares slot n+3 and slots after n=3 with the base station for downlink transmission.

### Embodiment 1: Introducing the CG-PUSCH COT Sharing Information Parameter Table, i.e. the Sharing Information List

Referring to the CG-PUSCH COT-sharing mode in the NRU system, a higher-layer sharing information parameter table, such as the cg-COT-SharingList, is introduced to configure the UE in tabular form. Each row of the table provides COT sharing information by a higher-layer parameter CG-COT-Sharing, and one row needs to be reserved in the table to indicate that COT sharing is not available.

The higher-layer parameter CG-COT-Sharing used for indicating COT sharing information provides the following COT sharing information:
1) ‘noCOT-sharing’ indicating that COT sharing is not available; and
2) ‘cot-Sharing’ indicating COT sharing information during COT sharing. The cot-Sharing includes the following parameters:
a) ‘duration’ indicating the number of slots in which the base station can perform downlink transmission within the COT initiated by the UE. Considering that the COT of 5 ms with a subcarrier spacing of 960 kHz includes 320 slots, the value range for the parameter ‘duration’ is {1 . . . 319}.
b) ‘offset’ indicating the number of spaced slots between the detection of the CG-UCI carrying COT sharing information and the start of downlink transmission by the base station. The value range is also {1 . . . 319}.
c) Unlike the NRU system, the concept of channel access priority is not introduced in the high frequencies. Therefore, there is no need to introduce parameters related to channel access priority in the COT sharing information.

Based on the above higher-layer parameter indicating the COT sharing information, the cg-COT-SharingList configured at the higher layer for the UE needs to include one or more CG-COT-Sharing, corresponding to different rows in the parameter table. In one example, the sharing information parameter table is shown as Table 1.

TABLE 1
Example of Sharing Information Parameter Representation

| CG-PUSCH COT | CG-PUSCH COT |
|---|---|
| Sharing Parameter | Sharing Information |
| CG-COT-Sharing1 | noCOT-sharing |
| CG-COT-Sharing2 | {duration1, offset1} |
| . . . | . . . |

After the base station configures the COT sharing information parameter table for the UE over the higher-layer parameter, the UE may carry the CG-UCI in the transmitted CG-PUSCH to instruct the currently applied COT sharing information to the base station.

In some embodiments, as shown in FIG. 11, the base station detects one row index indicated in the CG-UCI in slot n. The COT sharing information corresponding to the row index includes: the number of downlink transmission slots D=duration1, and the offset value O=offset1, wherein the offset1 is 3, then the base station starts sharing the COT initiated by the UE from slot n+3 and transmits downlink for duration1 slots.

### Embodiment 2: Not Introducing the CG-PUSCH COT Sharing Information Parameter Table

As the concept of channel access priority is not introduced in the high frequencies, the CG-PUSCH COT sharing information only needs to indicate the starting position and the number of transmission slots for downlink transmission. Therefore, the indication method for CG-PUSCH COT sharing information can be simplified. That is, without introducing the CG-PUSCH COT sharing information parameter table, the starting position and the number of transmission slots for downlink transmission during COT sharing are directly configured over higher-layer parameters. The higher-layer parameters include:

1) Higher-layer parameter cg-COT-SharingOffset indicating the number of spaced slots between the detection of the CG-UCI carrying COT sharing information and the start of downlink transmission by the base station. The value range is {1 . . . 319}.

2) An additionally introduced higher-layer parameter cg-COT-SharingDuration indicating the number of slots in which the base station can perform downlink transmission within the COT initiated by the UE. The value range is {1 . . . 319}.

In this case, the CG-UCI needs to include 1-bit information (i.e., sharing indication information) indicating COT sharing. For example, bit field 0 indicates that the base station cannot share the COT initiated by the UE, and bit field 1 indicates that the base station can share the COT initiated by the UE.

In some embodiments, as shown in FIG. 12, the base station detects in slot n that the bit field indicating COT sharing in the CG-UCI is 1, that is, the base station can share the COT initiated by the UE. Therefore, the base station can start sharing the COT initiated by the UE from slot n+O, and transmit downlink for D slots. O represents the offset value 3 configured by the higher-layer parameter cg-COT-SharingOffset, and D represents the number of downlink transmission slots configured by the higher-layer parameter cg-COT-SharingDuration.

### Channel Access Type Switching in the High Frequencies

In the NRU system, in the case that the UE detects that its uplink transmission is performed in the COT initiated by the base station, the UE switches from the Type-1 channel access to the Type-2A channel access in the COT-sharing mode. In the high frequencies, there are two types of COT-sharing modes supported: 1) When sharing the COT, the responding device does not need to perform the LBT (i.e., the Type-3 LBT), and directly performs the transmission; 2) When sharing the COT, in the case that the interval between the transmission of the responding device and the transmission of the initiating device falls within the specified gap (i.e., the first interval), then there is no need to perform the LBT, and transmission is proceeded directly. Otherwise, the Type-2 LBT needs to be performed prior to the transmission. Therefore, with respect to the switching of channel access types in the high frequencies, it is necessary to determine which channel access type to switch to from the Type-1 channel access.

### Embodiment 3: Always Switching from the Type-1 Channel Access to the Type-2 Channel Access

In the high-frequency unlicensed bands, in the case that the base station schedules an uplink transmission and instructs the UE to perform the Type-1 LBT, and subsequently the UE discovers over DCI 2_0 that the scheduled uplink transmission is performed within the time-frequency domain resources corresponding to the COT of the base station, then regardless of the COT-sharing mode currently applied, the UE always switches from the Type-1 channel access to the Type-2 channel access.

In some embodiments, as shown in FIG. 13, the base station schedules the PUSCH not within a previous COT (i.e., a COT 1301) over DCI 1. Therefore, it is necessary to instruct the UE to perform the Type-1 LBT over the DCI 1. Subsequently, the base station reacquires a new COT (i.e., a COT 1302), and the UE discovers over the DCI 2 on the COT 1302 that the previously scheduled PUSCH is performed within the time-frequency domain resources corresponding to the COT 1302. In this case, in the COT 1302, the UE switches from the Type-1 LBT to the Type-2 LBT in the COT-sharing mode, thereby simplifying the LBT process.

Furthermore, considering that the Type-2 LBT is a capability of the UE in the high frequencies, some UEs may lack the capability and therefore cannot perform the Type-2 LBT. Hence, with respect to UEs that do not support the Type-2 LBT, even if they meet the condition for the channel access type switching mentioned above, the Type-1 LBT is still performed prior to the uplink transmission.

### Embodiment 4: Consistency of Switched Channel Access with COT Sharing

As described above, the high frequencies differ from the NRU system in that they support two types of COT-sharing modes. With respect to the former type of COT-sharing mode, the responding device does not need to perform LBT prior to transmission. In this case, the UE still switching from the Type-1 LBT to the Type-2 LBT is not appropriate.

With respect to the channel access type switching manner in the high frequencies, the LBT type performed by the base station during COT sharing is referenced. The channel access type switching manner is as follows.

1) With respect to COT sharing scenarios where the responding device always performs the Type-3 LBT (i.e., no LBT required), in the case that the UE meets the condition for channel access type switching, the UE switches from the Type-1 LBT to the Type-3 LBT.

2) With respect to COT sharing scenarios where the LBT type performed by the responding device depends on the interval between the transmission of the responding device and the transmission of the initiating device, in the case that the UE meets the condition for channel access type switching, the UE switches from the Type-1 LBT to the Type-2 LBT.

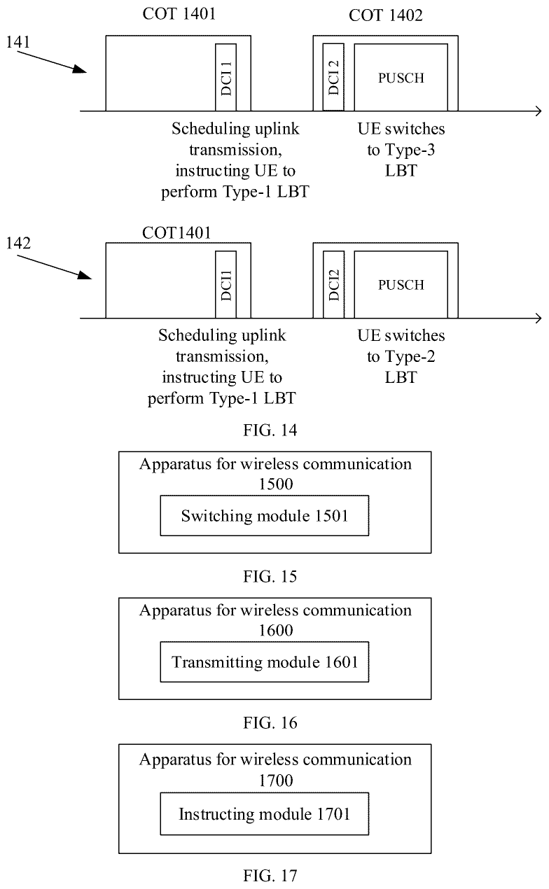

In some embodiments, as shown in FIG. 14, the base station schedules the PUSCH not within the previous COT (i.e., a COT 1401) over DCI 1. Therefore, it is necessary to instruct the UE to perform the Type1 LBT over the DCI 1. Subsequently, the base station reacquires a new COT (i.e., a COT 1402), and the UE discovers over the DCI 2 on the COT 1402 that the previously scheduled PUSCH is performed within the time-frequency domain resources corresponding to the COT 1402. In this case:

1) During COT sharing, in the case that the responding device always performs the Type-3 LBT, that is, there is no need to perform the LBT prior to transmission, as shown in 141, the UE switches from the Type-1 LBT to the Type-3 LBT.

2) During COT sharing, in the case that the Type-2 LBT/Type-3 LBT performed by the responding device depends on the interval between the transmission of the responding device and the transmission of the initiating device, as shown in 142, the UE switches from the Type-1 LBT to the Type-2 LBT.

The above manner ensures that the channel access type upon switching is consistent with the LBT type performed by the responding device during COT sharing. However, it is necessary to address how the UE determines which COT-sharing mode is currently being applied.

In the embodiments of the present disclosure, whether a gap is defined in the current COT sharing scenario is indicated over a system message. In the case of indicating that no gap is defined, the first type of COT-sharing mode is applied, that is, the responding device always performs the Type-3 LBT during COT sharing. In the case of indicating that the gap is defined, the second type of COT-sharing mode is applied, that is, the Type-2 LBT/Type-3 LBT performed by the responding device during COT sharing depends on whether the interval between the transmission of the responding device and the transmission of the initiating device is greater than the defined gap.

In some embodiments, whether the gap is defined in the current COT sharing scenario is indicated over the SIB 1 in the system message.

In addition, whether the gap is defined during COT sharing between the base station and the UE may be configured over RRC parameters, e.g., {maxGap, no-maxGap}, wherein maxGap represents the gap is defined, and no-maxGap represents the gap is not defined. In this case, different UEs in the same cell may apply different COT-sharing modes and different channel access type switching manners based on RRC configuration.

Furthermore, considering that the Type-2 LBT is the capability of the UE in the high frequencies, some UEs may lack the capability and therefore cannot perform the Type-2 LBT. Hence, with respect to UEs that do not support the Type-2 LBT, even if they meet the condition for the channel access type switching mentioned above, the Type-1 LBT is still performed prior to the uplink transmission.

Some embodiments of the present disclosure further provide a COT sharing manner for CG-PUSCH in high-frequency unlicensed bands.

By introducing the CG-PUSCH COT sharing information parameter table and indicating the currently applied COT sharing information over CG-UCI, different numbers of downlink transmission slots and offset values may be provided for CG-PUSCH COT sharing. Alternatively, the number of slots and offset values for CG-PUSCH COT sharing can be directly configured over higher-layer parameters, and in this case, CG-UCI only needs a 1-bit indication of whether the CG-PUSCH COT sharing can be performed.

Some embodiments of the present disclosure further provide a channel access type switching manner based on COT sharing in the high-frequency unlicensed bands.

Switching manner 1: In the case that the condition for channel access type switching is met, the Type-1 LBT is always switched to the Type-2 LBT. In this case, the UE does not need to know which COT-sharing mode is currently being applied.

Switching manner 2: The currently applied COT-sharing mode is indicated by the system message or configured over the RRC configuration, such that channel access type to switch to is determined, thereby ensuring that the channel access type after switching is consistent with the LBT type performed by the responding device during COT sharing.

The method for wireless communication according to the embodiments of the present disclosure is designed based on the high frequencies ranging from 52.6 GHz to 71 GHz. The method can be extended to any frequency band with the CG-PUSCH COT sharing manner and the channel access type switching manner based on COT sharing.

The exemplary embodiments of the present disclosure have been described in detail with reference to the accompanying drawings. However, the present disclosure is not limited to the specific details of the above embodiments, and various simple modifications may be made to the technical solutions of the present disclosure within the technical idea of the present disclosure, and these simple modifications all fall within the protection scope of the present disclosure. For example, the various specific technical features described in the above specific embodiments may be combined in any suitable manner without contradiction, and various possible combinations are not illustrated in the present disclosure, thereby avoiding unnecessary repetition. For another example, various embodiments of the present disclosure may be combined arbitrarily, and combined embodiments should be considered as the contents disclosed in the present disclosure as long as they do not violate the concept of the present disclosure. For another example, on the premise of no conflict, the embodiments described in the present disclosure and/or the technical features of the embodiments may be arbitrarily combined with the related art, and the combined technical solutions also fall within the protection scope of the present disclosure.

It is also understandable that in the various method embodiments of the present disclosure, the numerical order of the above-mentioned processes does not imply the sequence of execution. The execution order of these processes is determined by their functions and internal logic, and do not impose any limitation on the implementation of the embodiments of the present disclosure. Furthermore, in the embodiments of the present disclosure, the terms “downlink,” “uplink,” and “sidelink” indicates indicate the transmission direction of signals or data, wherein “downlink” indicates that the transmission direction of signals or data is a first direction transmitted from a station to a user equipment of a cell, “uplink” indicates that the transmission direction of signals or data is a second direction transmitted from a user equipment of a cell to a station, and “sidelink” indicates that the transmission direction of signals or data is a third direction transmitted from a user equipment 1 to a user equipment 2. For example, “downlink signal” indicates that the transmission direction of the signal is the first direction. In addition, in the embodiments of the present disclosure, the term “and/or” is only an association relationship that describes the association objects, and indicates that three relationships may be present. For example, the phrase “A and/or B” means (A), (B), or (A and B). In addition, the symbol “/” herein generally indicates an “or” relationship between the associated objects.

FIG. 15 is a schematic diagram of the structural composition of an apparatus 1500 for wireless communication according to some embodiments of the present disclosure. The apparatus 1500 is applicable to a terminal device. As shown in FIG. 15, the apparatus 1500 includes a switching module 1501.

The switching module 1501 is configured to, in the case that the terminal device is instructed to perform Type-1 LBT and first transmission scheduled or configured is carried on a first resource, switch a channel access type of the terminal device from the Type-1 LBT to a target channel access type. The first resource is a resource corresponding to a first COT (COT 1), the COT 1 being a COT initiated by a network device, and the target channel access type is Type-2 LBT or Type-3 LBT.

In some embodiments, the target channel access type is the Type-2 LBT.

In some embodiments, in the case that the terminal device supports the Type-2 LBT, the target channel access type is the Type-2 LBT.

In some embodiments, the target channel access type is determined based on whether the terminal device is configured with first indication information. The first indication information indicates whether the network device is configured with a first interval, wherein the first interval is configured to determine the channel access type of the network device on a second COT (COT 2), the COT 2 being a COT initiated by the terminal device.

In some embodiments, the first indication information indicates the first interval.

In some embodiments,
in the case that the terminal device is not configured with the first indication information, the target channel access type is the Type-3 LBT; or
in the case that the terminal device is configured with the first indication information, the target channel access type is the Type-2 LBT.

In some embodiments, the first indication information is configured by at least one of:
indicating the first indication information over a system message; or
configurating the first indication information at a higher layer.

In some embodiments, the first indication information is configured over the SIB 1 in the system message.

In some embodiments, in the case that the terminal device does not support the Type-2 LBT, the channel access type of the terminal device remains the Type-1 LBT.

In some embodiments, in the case that the first transmission is not performed on the first resource, the terminal device accesses a channel based on the Type-1 LBT.

In some embodiments, the apparatus 1500 further includes a transmitting module configured to transmit CG-UCI to a network device. The CG-UCI indicates whether the network device is instructed to share a third COT (COT 3) using target COT sharing information, wherein the COT 3 is a COT initiated by the terminal device, and the target COT sharing information includes a duration and a time offset.

In some embodiments, the duration is less than 320 slots.

In some embodiments, the target COT sharing information does not include parameters related to channel access priority.

In some embodiments, the target COT sharing information is determined based on index information and sharing information list carried by the UCI.

In some embodiments, the sharing information list is configured at the higher layer of the network device.

In some embodiments, in the case that the index information corresponds to first information in the sharing information list, the CG-UCI indicates that the network device is instructed not to share the COT 3, and the first information indicates that COT sharing is not available.

In some embodiments, in the case that the index information corresponds to sharing information in the sharing information list, the CG-UCI indicates that the network device is instructed to share the COT 3 using target COT sharing information. The target COT sharing information is sharing information corresponding to the index information in the sharing information list.

In some embodiments, the target COT sharing information is configured sharing information.

In some embodiments, the target COT sharing information is sharing information configured at the higher layer of the network device.

In some embodiments, the CG-UCI carries second information, wherein a value of the second information indicates whether the network device is configured to share the COT 3. In the case that the network device is configured to share the COT 3, the network device shares the COT 3 using the target COT sharing information.

In some embodiments, the second information taking a first value indicates that the network device is configured to share the COT 3; or the second information taking a second value indicates that the network device is not configured to share the COT 3.

FIG. 16 is a schematic diagram of the structural composition of an apparatus 1600 for wireless communication according to some embodiments of the present disclosure. The apparatus 1600 is applicable to a terminal device. As shown in FIG. 16, the apparatus 1600 for wireless communication includes: a first transmitting module 1601.

The first transmitting module 1601 is configured to transmit CG-UCI to a network device. The CG-UCI indicates whether the network device is instructed to share a third COT (COT 3) using target COT sharing information, wherein the COT 3 is a COT initiated by the terminal device, and the target COT sharing information includes a duration and a time offset.

In some embodiments, the duration is less than 320 slots.

In some embodiments, the sharing information does not include parameters related to channel access priority.

In some embodiments, the target COT sharing information is determined based on index information and sharing information list carried by the UCI.

In some embodiments, the sharing information list is configured at the higher layer of the network device.

In some embodiments, in the case that the index information corresponds to first information in the sharing information list, the CG-UCI indicates that the network device is instructed not to share the COT 3, and the first information indicates that COT sharing is not available.

In some embodiments, in the case that the index information corresponds to sharing information in the sharing information list, the CG-UCI indicates that the network device is instructed to share the COT 3 using target COT sharing information. The target COT sharing information is sharing information corresponding to the index information in the sharing information list.

In some embodiments, the target COT sharing information is configured sharing information.

In some embodiments, the target COT sharing information is sharing information configured at the higher layer of the network device.

In some embodiments, the CG-UCI carries the second information, wherein a value of the second information indicates that the network device is configured to share the COT 3. In the case that the network device is configured to share the COT 3, the network device shares the COT 3 using the target COT sharing information.

In some embodiments, the second information taking a first value indicates that the network device is configured to share the COT 3; or the second information taking a second value indicates that the network device is not configured to share the COT 3.

FIG. 17 is a schematic diagram of the structural composition of an apparatus 1700 for wireless communication according to some embodiments of the present disclosure. The apparatus 1700 is applicable to a network device. As shown in FIG. 17, the apparatus 1700 for wireless communication includes: an instructing module 1701.

The instructing module 1701 is configured to instruct a terminal device to perform Type-1 LBT. The first transmission scheduled or configured for the terminal device is carried on a first resource, and the channel access type of the terminal device is switched from the Type-1 LBT to a target channel access type, wherein the first resource is a resource corresponding to a first COT (COT 1), the COT 1 being a COT initiated by a network device, and the target channel access type is Type-2 LBT or Type-3 LBT.

In some embodiments, the target channel access type is the Type-2 LBT.

In some embodiments, in the case that the terminal device supports the Type-2 LBT, the target channel access type is the Type-2 LBT.

In some embodiments, the target channel access type is determined based on whether the terminal device is configured with first indication information. The first indication information indicates whether the network device is configured with a first interval, wherein the first interval is configured to determine the channel access type of the network device on a second COT (COT 2), the second COT 2 being a COT initiated by the terminal device.

In some embodiments, the first indication information indicates the first interval.

In some embodiments, in the case that the terminal device is not configured with the first indication information, the target channel access type is the Type-3 LBT; or

in the case that the terminal device is configured with the first indication information, the target channel access type is the Type-2 LBT.

In some embodiments, the first indication information is configured by at least one of:
indicating the first indication information over a system message; or
configuring the first indication information at a higher layer.

In some embodiments, the first indication information is configured over the SIB1 in the system message.

In some embodiments, in the case that the terminal device does not support the Type-2 LBT, the channel access type of the terminal device remains the Type-1 LBT.

In some embodiments, in the case that the first transmission is not performed on the first resource, the terminal device accesses a channel based on the Type-1 LBT.

In some embodiments, the apparatus 1700 further includes:
a receiving module, configured to receive CG-UCI from the terminal device. The CG-UCI indicates whether the network device is instructed to share a third COT (COT 3) using target COT sharing information, wherein the COT 3 is a COT initiated by the terminal device, and the target COT sharing information includes a duration and a time offset.

In some embodiments, the duration is less than 320 slots.

In some embodiments, the target COT sharing information does not include parameters related to channel access priority.

In some embodiments, the target COT sharing information is determined based on index information and sharing information list carried by the UCI.

In some embodiments, the sharing information list is configured at the higher layer of the network device.

In some embodiments, in the case that the index information corresponds to the first information in the sharing information list, the CG-UCI indicates that the network device is instructed not to share the COT 3, and the first information indicates that COT sharing is not available.

In some embodiments, in the case that the index information corresponds to sharing information in the sharing information list, the CG-UCI indicates that the network device is instructed to share the COT 3 using target COT sharing information. The target COT sharing information is sharing information corresponding to the index information in the sharing information list.

In some embodiments, the target COT sharing information is configured sharing information.

In some embodiments, the target COT sharing information is sharing information configured at the higher layer of the network device.

In some embodiments, the CG-UCI carries second information, wherein a value of the second information indicates whether the network device is configured to share the COT 3. In the case that the network device is configured to share the COT 3, the network device shares the COT 3 using the target COT sharing information.

In some embodiments, the second information taking a first value indicates that the network device is configured to share the COT 3; or
the second information taking a second value indicates that the network device is not configured to share the COT 3.

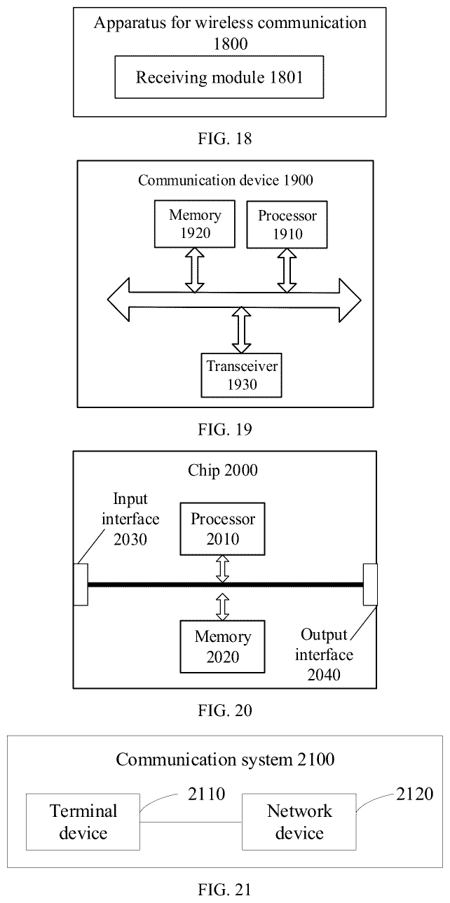

FIG. 18 is a schematic diagram of the structural composition of an apparatus 1800 for wireless communication according to some embodiments of the present disclosure. The apparatus 1800 is applicable to a network device. As shown in FIG. 18, the apparatus 1800 includes a receiving module 1801.

The receiving module 1801 is configured to receive CG-UCI from a terminal device, wherein the CG-UCI indicates whether the network device is instructed to share a third COT (COT 3) using target COT sharing information, the COT 3 being a COT initiated by the terminal device, and the target COT sharing information including a duration and a time offset.

In some embodiments, the duration is less than 320 slots.

In some embodiments, the sharing information does not include parameters related to channel access priority.

In some embodiments, the target COT sharing information is determined based on index information and sharing information list carried by the UCI.

In some embodiments, the sharing information list is configured at the higher layer of the network device.

In some embodiments, in the case that the index information corresponds to first information in the sharing information list, the CG-UCI indicates that the network device is instructed not to share the COT 3, and the first information indicates that COT sharing is not available.

In some embodiments, in the case that the index information corresponds to sharing information in the sharing information list, the CG-UCI indicates that the network device is instructed to share the COT 3 using target COT sharing information. The target COT sharing information is sharing information corresponding to the index information in the sharing information list.

In some embodiments, the target COT sharing information is configured sharing information.

In some embodiments, the target COT sharing information is sharing information configured at the higher layer of the network device.

In some embodiments, the CG-UCI carries second information, wherein a value of the second information indicates whether the network device is configured to share the COT 3. In the case that the network device is configured to share the COT 3, the network device shares the COT 3 using the target COT sharing information.

In some embodiments, the second information taking a first value indicates that the network device is configured to share the COT 3; or
the second information taking a second value indicates that the network device is not configured to share the COT 3.

It is understandable by those skilled in the art that the related description of the apparatus for wireless communication according to the embodiments of the present disclosure can be understood by referring to the related description of the method for wireless communication according to the embodiments of the present disclosure.

FIG. 19 is a schematic structural diagram of a communication device 1900 according to some embodiments of the present disclosure. The communication device is a terminal device or a network device. The communication device 1900 shown in FIG. 19 includes a processor 1910. The processor 1910, when loading and running one or more computer programs from a memory, is caused to perform the methods in the embodiments of the present disclosure.

In some embodiments, as shown in FIG. 19, the communication device 1900 further includes a memory 1920. The processor 1910, when loading and running one or more computer programs from the memory 1920, is caused to perform the methods in the embodiments of the present disclosure.

The memory 1920 is a separate device independent from the processor 1910, or the memory 1920 is integrated within the processor 1910.

In some embodiments, as shown in FIG. 19, the communication device 1900 further includes a transceiver 1930. The processor 1910 controls the transceiver 1930 to communicate with other devices. For example, the processor 1910 controls the transceiver 1930 to transmit information or data to other devices, or to receive information or data transmitted by other devices.

The transceiver 1930 includes a transmitter and a receiver. The transceiver 1930 further includes one or more antennas.

In some embodiments, the communication device 1900 is the network device of the embodiments of the present disclosure, and the communication device 1900 performs corresponding flows performed by the network device in various methods of the embodiments of the present disclosure, which is not repeated herein for brevity.

In some embodiments, the communication device 1900 is the mobile terminal/terminal device of the embodiments of the present disclosure, and the communication device 1900 performs corresponding flows performed by the mobile terminal/terminal device in various methods of the embodiments of the present disclosure, which is not repeated herein for brevity.

FIG. 20 is a schematic structural diagram of a chip according to some embodiments of the present disclosure. The chip 2000 shown in FIG. 20 includes a processor 2010. The processor 2010, when loading and running one or more computer programs from a memory, is caused to perform the methods in the embodiments of the present disclosure.

In some embodiments, as shown in FIG. 20, the chip 2000 further includes a memory 2020. The processor 2010, when loading and running one or more computer programs from the memory 2020, is caused to perform the methods in the embodiments of the present disclosure.

The memory 2020 is a separate device independent from the processor 2010, or the memory 2020 is integrated within the processor 2010.

In some embodiments, the chip 2000 further includes an input interface 2030. The processor 2010 controls the input interface 2030 to communicate with other devices or chips. For example, the processor 2010 controls the input interface 2030 to acquire information or data transmitted by other devices or chips.

In some embodiments, the chip 2000 further includes an output interface 2040. The processor 2010 controls the output interface 2040 to communicate with other devices or chips. For example, the processor 2010 controls the output interface 2040 to output information or data to other devices or chips.

In some embodiments, the chip is applicable to the network device in the embodiments of the present disclosure, and the chip performs corresponding flows performed by the network device in various methods of the embodiments of the present disclosure, which is not repeated herein for brevity.

In some embodiments, the chip is applicable to the mobile terminal/terminal device in the embodiments of the present disclosure, and the chip performs corresponding flows performed by the mobile terminal/terminal device in various methods of the embodiments of the present disclosure, which is not repeated herein for brevity.

It is understandable that the chip mentioned in the embodiments of the present disclosure may also be referred to as system-on-chip, system chip, chip system, or on-chip system.

FIG. 21 is a schematic block diagram of a communication system 2100 according to some embodiments of the present disclosure. As shown in FIG. 21, the communication system 2100 includes a terminal device 2110 and a network device 2120.

The terminal device 2110 is configured to perform corresponding functions performed by the terminal device in the above methods, and the network device 2120 is configured to perform corresponding functions performed by the network device in the above methods, which is not repeated herein for brevity.

It is understandable that the processor of the embodiments of the present disclosure may be an integrated circuit chip with signal processing capabilities. In implementation, the processes of the above method embodiments can be performed by hardware integrated logic circuits or software instructions in the processor. The above processor can be a general-purpose processor, a digital signal processor (DSP), an application specific integrated circuit (ASIC), a field programmable gate array (FPGA), or another programmable logic device, discrete gate or transistor logic device, or discrete hardware assembly. The methods, processes, and logic block diagrams disclosed in the embodiments of the present disclosure can be implemented or performed. The general-purpose processor can be a microprocessor or the processor can be any conventional processor or the like. The processes of the methods disclosed in connection with the embodiments of the present disclosure can be directly embodied as hardware and performed by a coding processor, or performed by a combination of hardware and software modules in the coding processor. The software module can be located in a random access memory, a flash memory, a read-only memory, a programmable read-only memory, an electrically erasable programmable memory, a register, or other mature storage medium in the art. The storage medium is located in a memory, and the processor reads information in the memory to perform the processes of the above methods in combination with the hardware of the memory.

It is understandable that the memory in the embodiments of the present disclosure can be either a volatile memory or a non-volatile memory, or can include both the volatile memory and the non-volatile memory. The non-volatile memory can be a read-only memory (ROM), a programmable ROM (PROM), an erasable PROM (EPROM), an electrically EPROM (EEPROM), or a flash memory. The volatile memory can be a random access memory (RAM) which serves as an external cache. By way of example and not limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the memory of the systems and methods described herein is intended to include, but not limited to, these and any other suitable types of memories.

It is understandable that the above-mentioned memories are exemplary but not limiting. For example, the memory in the embodiments of the present disclosure can also be an SRAM, a DRAM, an SDRAM, a DDR SDRAM, an ESDRAM, an SLDRAM, and a DR RAM, or the like.

That is, the memory in the embodiments of the present disclosure is intended to include, but not limited to, these and any other suitable types of memories.

Some embodiments of the present disclosure provide a non-transitory computer-readable storage medium. The non-transitory computer-readable storage medium is configured to store one or more computer programs.

In some embodiments, the non-transitory computer-readable storage medium is applicable to the network device in the embodiments of the present disclosure, and the one or more computer programs, when loaded and run on a computer, cause the computer to perform corresponding flows performed by the network device in various methods of the embodiments of the present disclosure, which is not repeated herein for brevity.

In some embodiments, the non-transitory computer-readable storage medium is applicable to the mobile terminal/terminal device in the embodiments of the present disclosure, and the one or more computer programs, when loaded and run on a computer, cause the computer to perform corresponding flows performed by the mobile terminal/terminal device in various methods of the embodiments of the present disclosure, which is not repeated herein for brevity.

Some embodiments of the present disclosure provide a computer program product. The computer program product includes one or more computer program instructions.

In some embodiments, the computer program product is applicable to the network device in the embodiments of the present disclosure, and the one or more computer program instructions, when loaded and executed on a computer, cause the computer to perform corresponding flows performed by the network device in various methods of the embodiments of the present disclosure, which is not repeated herein for brevity.

In some embodiments, the computer program product is applicable to the mobile terminal/terminal device in the embodiments of the present disclosure, and the one or more computer program instructions, when loaded and executed on a computer, cause the computer to perform corresponding flows performed by the mobile terminal/terminal device in various methods of the embodiments of the present disclosure, which is not repeated herein for brevity.

Some embodiments of the present disclosure provide a computer program.

In some embodiments, the one or more computer programs are applicable to the network device in the embodiments of the present disclosure, and the one or more computer programs, when loaded and run on a computer, cause the computer to perform corresponding flows performed by the network device in various methods of the embodiments of the present disclosure, which is not repeated herein for brevity.

In some embodiments, the one or more computer programs are applicable to the mobile terminal/terminal device in the embodiments of the present disclosure, and the one or more computer programs, when loaded and run on a computer, cause the computer to perform corresponding flows performed by the mobile terminal/terminal device in various methods of the embodiments of the present disclosure, which is not repeated herein for brevity.

Those of ordinary skill in the art will appreciate that the units and algorithm processes of various examples described in connection with the embodiments disclosed herein can be performed in electronic hardware, or a combination of computer software and electronic hardware. Whether these functions are performed in hardware or software depends on the particular application and design constraints of the technical solutions. Those skilled in the art may perform the described functions in varying ways for each particular application, but such implementations are not to be interpreted as departing from the scope of the present disclosure.

Those skilled in the art can clearly understand that, for convenience and brevity in description, the specific working processes of the systems, apparatuses, and units described above can refer to the corresponding processes in the aforementioned method embodiments, which are not repeated herein.

In the several embodiments provided in the present disclosure, it is understandable that the disclosed systems, apparatuses, and methods can be performed in other ways. For example, the apparatus embodiments are merely illustrative. For example, the division of the units is only one type of logical functional division, and other divisions may be achieved in practice. For example, a plurality of units or components may be combined or integrated into another system, or some features may be omitted, or not executed. In addition, the shown or discussed mutual coupling or direct coupling or communication connection may be an indirect coupling or communication connection over some interfaces, apparatuses, or units, and may be in an electrical, mechanical, or another form.

The units described as separate parts may or may not be physically separate, and parts displayed as units may or may not be physical units, that is, the units may be located in one location, or may be distributed on a plurality of network units. Some or all of the units can be selected based on actual needs to achieve the purpose of the solutions of the embodiments.

In addition, various functional units in the embodiments of the present disclosure can be integrated into one processing unit, or various units can be physically present separately, or two or more units can be integrated into one unit.

The functions can be stored in a non-transitory computer-readable storage medium if they are performed in software functional units and sold or used as independent products. Based on such understandings, the technical solutions of the present disclosure substantially or a part of the technical solutions that contributes to the related art, or a part of the technical solutions, can be embodied in a software product, which is stored in a storage medium and includes several instructions for causing a computer device (which can be a personal computer, a server, or a network device) to perform all or part of the processes of the methods as defined in the embodiments of the present disclosure. The aforementioned storage medium includes various medium capable of storing program codes, such as a U-disk, a mobile hard disk, a read-only memory (ROM), a random-access memory (RAM), a magnetic disk, and an optical disk.

The above descriptions are only specific embodiments of the present disclosure, but the protection scope of the present disclosure is not limited to these. Any technical personnel skilled in the art can easily think of changes or substitutions within the technical scope disclosed herein, and these changes or substitutions should be covered within the protection scope of the present disclosure. Therefore, the protection scope of the present disclosure shall be subject to the protection scope of the claims.

1. A method for wireless communication, comprising:
transmitting, by a terminal device, configured grant-uplink control information (CG-UCI) to a network device, wherein the CG-UCI indicates whether the network device is instructed to share a third COT using target COT sharing information, the third COT being a COT initiated by the terminal device, and the target COT sharing information comprising a duration and a time offset.

2. The method according to claim 1, wherein the duration is less than 320 slots.

3. The method according to claim 1, wherein the sharing information does not comprise parameters related to channel access priority.

4. The method according to claim 1, wherein the target COT sharing information is determined based on index information and a sharing information list carried by the UCI.

5. The method according to claim 4, wherein in a case that the index information corresponds to first information in the sharing information list, the CG-UCI indicates that the network device is instructed not to share the third COT, wherein the first information indicates that COT sharing is not available.

6. The method according to claim 4, wherein in a case that the index information corresponds to sharing information in the sharing information list, the CG-UCI indicates that the network device is instructed to share the third COT using target COT sharing information, wherein the target COT sharing information is sharing information corresponding to the index information in the sharing information list.

7. The method according to claim 1, wherein the third COT is a shared time initiated by the terminal device and determined to be shared to the network device based on the CG-UCI, and the third COT is a COT accessed by the network device in the COT-sharing mode, wherein a channel access type of the network device is determined based on a first interval.

8. A terminal device, comprising:
a processor and a memory, wherein the memory is configured to store one or more computer programs, which when executed by the processor, cause the processor to:
transmit configured grant-uplink control information (CG-UCI) to a network device, wherein the CG-UCI indicates whether the network device is instructed to share a third COT using target COT sharing information, the third COT being a COT initiated by the terminal device, and the target COT sharing information comprising a duration and a time offset.

9. The terminal device according to claim 8, wherein the duration is less than 320 slots.

10. The terminal device according to claim 8, wherein the sharing information does not comprise parameters related to channel access priority.

11. The terminal device according to claim 8, wherein the target COT sharing information is determined based on index information and a sharing information list carried by the UCI.

12. The terminal device according to claim 11, wherein in a case that the index information corresponds to first information in the sharing information list, the CG-UCI indicates that the network device is instructed not to share the third COT, wherein the first information indicates that COT sharing is not available.

13. The terminal device according to claim 11, wherein in a case that the index information corresponds to sharing information in the sharing information list, the CG-UCI indicates that the network device is instructed to share the third COT using target COT sharing information, wherein the target COT sharing information is sharing information corresponding to the index information in the sharing information list.

14. A network device, comprising:
a processor and a memory, wherein the memory is configured to store one or more computer programs, which when executed by the processor, cause the processor to:
receive configured grant-uplink control information (CG-UCI) from a terminal device, wherein the CG-UCI indicates whether the network device is instructed to share a third COT using target COT sharing information, the third COT being a COT initiated by the terminal device, and the target COT sharing information comprising a duration and a time offset.

15. The network device according to claim 14, wherein the duration is less than 320 slots.

16. The network device according to claim 14, wherein the sharing information does not comprise parameters related to channel access priority.

17. The network device according to claim 14, wherein the target COT sharing information is determined based on index information and a sharing information list carried by the UCI.

18. The network device according to claim 17, wherein in a case that the index information corresponds to first information in the sharing information list, the CG-UCI indicates that the network device is instructed not to share the third COT, wherein the first information indicates that COT sharing is not available.

19. The network device according to claim 17, wherein in a case that the index information corresponds to sharing information in the sharing information list, the CG-UCI indicates that the network device is instructed to share the third COT using target COT sharing information, wherein the target COT sharing information is sharing information corresponding to the index information in the sharing information list.

20. A chip, comprising:
a processor, wherein the processor, when executing one or more computer programs from a memory, cause a device equipped with the chip to perform the method according to claim 1.
